(19) United States
(12) Patent Application Publication
(10) Pub. No.: US 2018/0231020 A1
(43) Pub. Date: Aug. 16, 2018

(54) GAS TURBINE ENGINE FAN BLADE WITH AXIAL LEAN

(71) Applicant: ROLLS-ROYCE plc, London (GB)

(72) Inventors: Mark J. WILSON, Nottingham (GB); Gabriel GONZALEZ-GUTIERREZ, Derby (GB); Marco BARALE, Derby (GB); Benedict PHELPS, Derby (GB); Kashmir S. JOHAL, Derby (GB); Nigel HS SMITH, Derby (GB)

(73) Assignee: ROLLS-ROYCE plc, London (GB)

(21) Appl. No.: 15/894,249

(22) Filed: Feb. 12, 2018

(30) Foreign Application Priority Data
Feb. 14, 2017 (GB) 1702383.9

(51) Int. Cl. F04D 29/38; F02K 3/06

(52) U.S. Cl. CPC F04D 29/386; F02K 3/06; F05D 2230/239; F05D 2220/32; F04D 29/388

(57) ABSTRACT

A fan blade for a gas turbine engine is arranged such that for any two points on its leading edge that are in the radially outer 40% of the blade span and are radially separated by at least 5% of the blade span, the radially outer of the two points is axially forward of the radially inner point. The radius of the leading edge of a given fan blade at the hub divided by the radius of the leading edge of the fan blade at the tip is less than or equal to 0.3. Such an arrangement may result in an improved operability range.

### CROSS-REFERENCE TO RELATED APPLICATIONS

This specification is based upon and claims the benefit of priority from UK Patent Application Number 1702383.9 filed on 14 Feb. 2017, the entire contents of which are incorporated herein by reference.

### BACKGROUND

### 1. Field of the Disclosure

This disclosure relates to a fan blade for a gas turbine engine, a fan stage comprising at least one such fan blade, and a gas turbine engine comprising such a fan stage.

### 2. Description of the Related Art

Modern gas turbine aero-engines typically comprise a fan, which compresses the incoming air and directs at least a portion of that air along a bypass duct, with the remainder of the air flowing through the engine core. The fan must be able to operate in a range of conditions, for example without stalling.

Modern large gas turbine engines are being designed to have lower specific thrust and higher fan tip loading than their predecessors. This may be achieved by driving the fan via a gearbox in order to reduce the rotational speed of the fan. Lower specific thrust and/or lower rotational speed and/or higher tip loading may be beneficial from an efficiency perspective, but may present significant operability challenges.

For example, as the cruise and sea level working lines separate at lower pressure ratios, the challenge to have sufficient stall (and flutter) margins relative to the sea level static (SLS) working line, and acceptable cruise working line efficiency becomes more difficult.

Accordingly, the design of modern turbofan gas turbine engines tends to decrease their operability range.

### SUMMARY

Accordingly, it would be desirable to be able to reduce increase the operability range of a gas turbine engine, for example to decrease its susceptibility to stall.

According to an aspect, there is provided a fan stage for a gas turbine engine, the fan stage defining axial, radial and circumferential directions, fan stage comprising a plurality of fan blades extending from a hub. Each fan blade comprises an aerofoil portion has a leading edge extending from a root to a tip, the radial distance between the leading edge at the root and the leading edge at the tip defining a blade span. For any two points on the leading edge of a fan blade that are in the radially outer 40% of the blade span and are radially separated by at least 5% of the blade span, the radially outer of the two points is axially forward of the radially inner point. The radius of the leading edge of a given fan blade at the hub divided by the radius of the leading edge of the fan blade at the tip may be less than or equal to 0.3. The radius of the leading edge of a given fan blade at the hub divided by the radius of the leading edge of the fan blade at the tip may be referred to as the hub to tip ratio, either of the fan blade or the fan stage.

The term “axially forward” may mean the same axial direction as the axial component of the direction from the trailing edge of the blade to the leading edge of the blade. The fan stage may rotate about the axial direction in use. The term “fan stage” may refer only to rotating components, for example comprising the hub and blades. Alternatively, the term “fan stage” may also comprise other components, including non-rotating components such as guide vanes immediately downstream of the fan blades.

Where reference is made to the axial, radial and circumferential directions, the skilled person will readily understand this to mean the conventional directions when the fan blade is assembled as part of a fan stage or is provided in a gas turbine engine. Viewing the blade along a circumferential direction may mean viewing the blade in side profile and/or in the meridional plane and/or projected onto a plane defined by the axial and radial directions.

Arrangements such as those described and/or claimed herein may reduce the radial pressure gradient (for example in the radially outer half and/or towards the tip) of the aerofoil during operation, for example on high working lines. This may provide a greater operability range and/or reduce the tendency of the blade to stall.

Optionally, for any two points on the leading edge of the fan blade that are radially closer to the tip than to the root and are radially separated by at least 5% of the blade span, the radially outer of the two points may be axially forward of the radially inner point.

Optionally, for any two points on the leading edge of the fan blade that are in the radially outer 40% of the blade span and have a difference in radius of at least 2% of the blade span, the radially outer of the two points may be axially forward of the radially inner point.

Optionally, for any two points on the leading edge of the fan blade that are radially closer to the tip than to the root and have a difference in radius of at least 2% of the blade span, the radially outer of the two points may be axially forward of the radially inner point.

The hub may be, or may comprise, a fan disc and/or may be driven by a shaft. The shaft itself may be driven by a turbine of a gas turbine engine. As used herein, in the term “hub to tip ratio”, the hub may refer to the part of the hub that is facing outwards, so as to form the gas-washed surface in use, in accordance with conventional use of the term.

In some arrangements, the radius of the leading edge of a given fan blade at the hub divided by the radius of the leading edge of the fan blade at the tip may be less than or equal to 0.37, for example less than or equal to 0.35, for example less than or equal to 0.33, for example less than or equal to 0.32, for example less than or equal to 0.31, for example less than or equal to 0.3, for example less than or equal to 0.29, for example less than or equal to 0.28, for example less than or equal to 0.27, for example less than or equal to 0.26, for example less than or equal to 0.25, for example less than or equal to 0.24, for example less than or equal to 0.23, for example less than or equal to 0.22.

For any two points on the leading edge of a fan blade that are radially closer to the tip than to the root and have a difference in radius of at least 1%, for example at least 2%, for example at least 3%, for example at least 4% of the blade span, the radially outer of the two points may axially forward of the radially inner point.

For any two points on the leading edge of a fan blade that are radially separated by at least 5% of the blade span, the radially outer of the two points may be axially forward of the radially inner point, for example regardless of the absolute radial position of the two points. Thus, in some arrangements, for any two points on the leading edge of a fan blade that are radially closer to the root than to the tip and are radially separated by at least 5% of the blade span, the radially outer of the two points may be axially forward of the radially inner point. In other arrangements, for any two points on the leading edge of a fan blade that are radially closer to the root than to the tip and are radially separated by at least 5% of the blade span, the radially outer of the two points may not be axially forward of the radially inner point, for example it may be axially rearward of or axially aligned with the radially inner point.

When viewed along a circumferential direction, the angle formed between the radial direction and a line drawn between any of the two points on the leading edge referred to herein may be in the range of from −6° and 0°, for example in the range of from −5° and −0.25°, for example −4° and −0.5°, for example −3° and −0.75°, for example −2° and −1°, where a negative angle indicates that the respective line has an axial component that is in the same direction as the axial component of the direction from a trailing edge to the leading edge of the blade.

When viewed along a circumferential direction, the angle (α) formed between the radial direction and a straight line (AC) drawn between the leading edge at the root and at the tip of any given fan blade is in the range of from −6° and −0.2°, for example in the range of from −5° and −0.25°, for example −4° and −0.5°, for example −3° and −0.75°, for example −2° and −1°, where a negative angle indicates that the respective line has an axial component that is in the same direction as the axial component of the direction from a trailing edge to the leading edge of the blade.

When viewed along a circumferential direction, the maximum perpendicular distance between any point on the leading edge and a straight line drawn between the leading edge at the root and at the tip may be 5% of blade span, for example 4%, 3%, 2%, 1%, 0.5% or 0.1% of the blade span.

The fan blade may comprise a platform. The fan blade may comprise a root portion. The root portion may extend between the platform and the root of the aerofoil portion. Alternatively, the aerofoil portion may extend directly from the platform, with no intermediate root portion, such that the root of the aerofoil foil portion is the root of the fan blade. A radially outer (gas washed) surface of the platform may correspond to the radially outer (gas washed) part of the hub.

Where the fan blade comprises a root portion, the radial extent of the root portion may be no more than 15%, for example no more than 10%, 7%, 5%, 3%, 2% or 1%, of the span of the aerofoil portion, for example.

The fan blade may comprise a tip portion that extends at least radially away from the tip of the aerofoil portion. Alternatively, the fan blade may comprise no tip portion, such that the tip of the aerofoil portion is also the tip of the fan blade.

Where the fan blade comprises a tip portion, the radial extent of the tip portion may be no more than 15%, for example no more than 10%, 7%, 5%, 3%, 2% or 1%, of the span of the aerofoil portion, for example.

A stacking axis of the aerofoil portion may be defined by a line joining the centroids of all of the aerofoil segments that are stacked to form the aerofoil portion. When viewed along a circumferential direction, the stacking axis may have a forward lean. For example, the angle formed between the radial direction and a straight line drawn between the stacking axis at the root and at the tip may be in the range of from −40° and 0°, for example −30° and −1°, for example −25° and −2°, for example −20° and −3°, for example −15° and −5°, for example −10° and −6°, where a negative angle indicates that the respective line has an axial component that is in the same direction as the axial component of the direction from a trailing edge to the leading edge of the blade. By way of further example, optionally the stacking axis may have a forward (negative) lean in the radially outer half of the aerofoil portion, for example only in the radially outer half of the aerofoil portion.

The aerofoil portion may have a trailing edge extending from a root to a tip. When viewed along a circumferential direction, the trailing edge may have a forward lean. For example, the angle formed between the radial direction and a straight line drawn between the trailing edge at the root and at the tip may be in the range of from −40° and 0°, for example −30° and −1°, for example −25° and −2.5°, for example −20° and −5°, for example −15° and −7.5°, for example around −10°, where a negative angle indicates that the respective line has an axial component that is in the same direction as the axial component of the direction from a trailing edge to the leading edge of the blade.

The trailing edge may be shaped such that the forward (negative) lean angle over a radially outer half of the trailing edge is greater, for example significantly greater, than the forward (negative) lean angle over a radially inner half of the trailing edge. For example, the forward (negative) lean angle over a radially outer half of the trailing may be at least 1.5 times, for example at least twice, for example at least 3, 4, 5, 6, 7, 8, 9 or 10 times the forward (negative) lean angle over a radially inner half of the trailing edge. In some arrangements, the trailing edge may be radial (including substantially radial) over a radially inner portion of the blade (or aerofoil portion), for example over a radially inner 10%, 20%, 30%, 40% or around 50%.

In any aspect or example of the present disclosure, the magnitude of the angle formed between the radial direction and a straight line drawn between the trailing edge at the root and at the tip may be greater than the magnitude of the angle formed between the radial direction and a straight line drawn between the leading edge at the root and at the tip. For example, the angle formed between the radial direction and a straight line drawn between the trailing edge at the root and at the tip may have a higher negative value than that of the of the angle formed between the radial direction and a straight line drawn between the leading edge at the root and at the tip. The angle formed between the radial direction and a straight line drawn between the trailing edge at the root and at the tip may be negative. The angle formed between the radial direction and a straight line drawn between the leading edge at the root and at the tip may be negative.

Any fan blade and/or aerofoil portion described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre, and/or from a metal, such as a titanium based metal or an aluminium based material (such as an Aluminium-Lithium alloy) or a steel based material.

The fan blades may be attached to the hub in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc.

By way of further example, the fan blades maybe formed integrally with a hub. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

By way of further example, the fan blades may be attached to a hub in a manner that allows their pitch to be varied.

According to an aspect, there is provided a gas turbine engine comprising at least one fan blade as described and/or claimed herein and/or a fan stage as described and/or claimed herein.

Such a gas turbine engine (which may, of course, be a turbofan gas turbine engine) may have a specific thrust of less than 15 lbf/lb/s (or approximately 150 N/Kg/s), for example less than 12 lbf/lb/s (or approximately 120 N/Kg/s), for example less than 10 lbf/lb/s (or approximately 110 N/Kg/s or 100 N/Kg/s), for example less than 9 lbf/lb/s (or approximately 90 N/Kg/s), for example less than 8.5 lbf/lb/s (or approximately 85 N/Kg/s), for example less than 8 lbf/lb/s (or approximately 80 N/Kg/s).

Any gas turbine engine described and/or claimed herein may have a fan tip loading (dH/Uₜᵢₚ²) at cruise conditions of greater than 0.3, for example in the range of from 0.3 to 0.37, for example 0.32 to 0.36, for example on the order of 0.35 (all units being JKg⁻¹K⁻¹/(ms⁻¹)²), where dH is the enthalpy rise across the fan (for example the 1-D average enthalpy rise of the flow across the fan at cruise conditions), and Uₜᵢₚ is the velocity of the tip, for example at cruise conditions, which may be calculated as the rotational speed multiplied by the tip radius at the leading edge. Cruise may be defined as the phase between the initial ascent and final descent of an aircraft to which the engine may be attached. As used herein, cruise may mean, for example, mid-cruise, i.e. mid-point (for example in terms of time and/or fuel burn) of a flight (or at least of the cruise phase of a flight).

The radius of the fan may be measured between the engine centreline and the tip of a fan blade at its leading edge. The fan diameter (which may simply be twice the radius of the fan) may be greater than 250 cm, for example greater than 260 cm, 270 cm, 280 cm, 290 cm, 300 cm, 310 cm, 320 cm, 330 cm, 340 cm or 350 cm.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than 10, for example greater than 11, for example greater than 11.5, for example greater than 12, for example greater than 13, for example greater than 14, for example greater than 15. The bypass duct may be substantially annular. The bypass duct may be radially outside the core engine. The radially outer surface of the bypass duct may be defined by a nacelle and/or a fan case.

A gas turbine engine as described and/or claimed herein may have any desired maximum thrust. Purely by way of non-limitative example, a gas turbine as described and/or claimed herein may be capable of producing at least 170 kN of thrust, for example at least 180 kN, for example at least 190 kN, for example at least 200 kN, for example at least 250 kN, for example at least 300 kN, for example at least 350 kN, for example at least 400 kN. The thrust referred to above may be at standard atmospheric conditions.

Such a gas turbine engine may be of any suitable form. For example, the gas turbine engine may be an aero gas turbine engine for use on aircraft. Such an engine may be a geared turbofan gas turbine engine, in which the fan stage is driven from a turbine via a gearbox, in order to reduce (or increase) the rotational speed of the fan stage compared with the driving turbine stage(s).

The arrangements of the present disclosure may be particularly effective in addressing any operability issues presented by the use of such lower speed fans, such as those driven via a gearbox.

The input to such a gearbox may be directly from a core shaft that connects a turbine to a compressor, or indirectly from the core shaft, for example via a spur shaft and/or gear. The core shaft may rigidly connect the turbine and the compressor, such that the turbine and compressor rotate at the same speed (with the fan rotating at a lower speed).

Any number of fan stages may be provided to an engine. For example, a gas turbine engine may have a single fan stage, such that the next downstream rotor stage after the fan is a compressor rotor stage, for example a compressor rotor stage in the core of the engine.

The skilled person will appreciate that except where mutually exclusive, a feature described in relation to any one of the above aspects may be applied to any other aspect. Furthermore, except where mutually exclusive, any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine on accordance with the present disclosure;

FIG. 2 is a side view of a fan blade according to an example of the present disclosure;

FIG. 3 is a close-up view of a leading edge portion of a fan blade according to an example of the present disclosure; and

FIG. 4 is a side view of a fan blade according to an example of the present disclosure.

### DETAILED DESCRIPTION OF THE DISCLOSURE

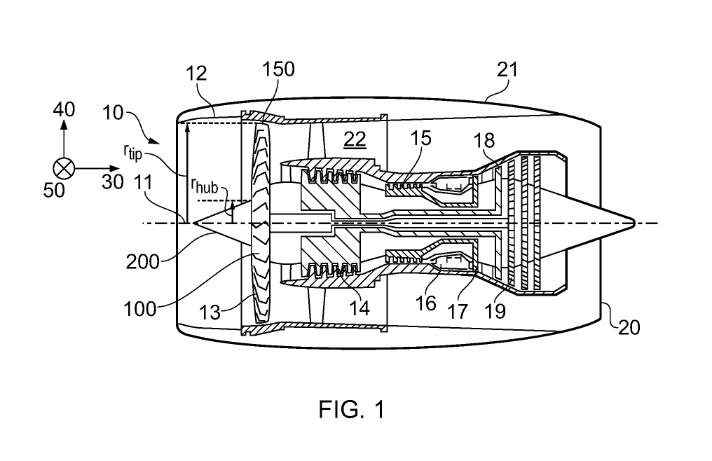

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

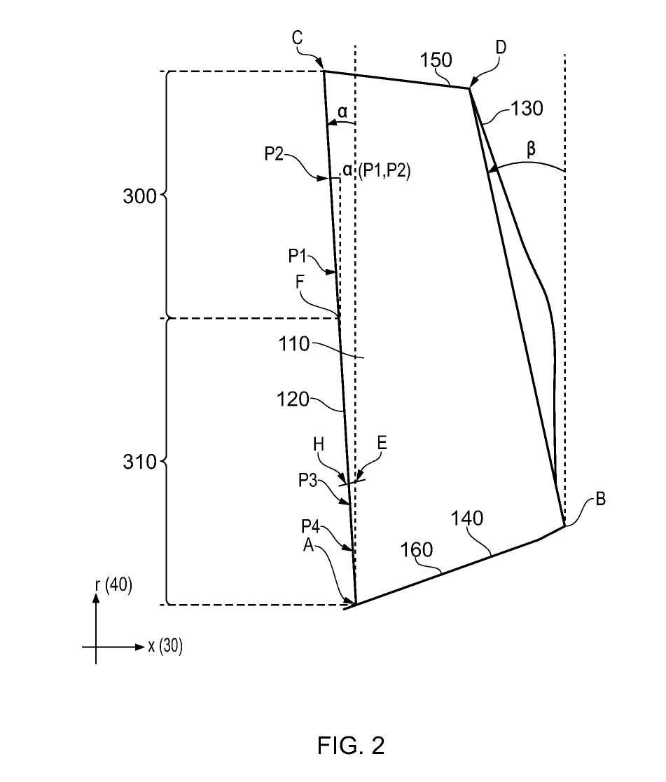

The gas turbine engine 10 and/or the fan stage 13 and/or the fan blades 100 of the fan stage 13 shown in FIG. 1 may be in accordance with examples of the present disclosure, aspects of which are described by way of example only in relation to FIGS. 2 to 6.

Any gas turbine engine in accordance with the present disclosure (such as the gas turbine engine 10 of FIG. 1) may, for example, have a specific thrust in the ranges described herein (for example less than 10) and/or a fan blade hub to tip ratio in the ranges described herein and/or a fan tip loading in the ranges described herein.

The present disclosure may relate to any suitable gas turbine engine. For example, other gas turbine engines to which the present disclosure may be applied may have related or alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan. The gas turbine engine shown in FIG. 1 has a mixed flow nozzle 20, meaning that the flow through the bypass duct 22 and the flow through the core 15, 16, 17, 18, 19 are mixed, or combined, before (or upstream of) the nozzle 20). However, this is not limiting, and any aspect of the present disclosure may also, for example, relate to engines 10 having a split flow nozzle, which may mean that the flow through the bypass duct 22 has its own nozzle that is separate to and may be radially outside a core engine nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example.

The geometry of the gas turbine engine 10, and components thereof, is defined by a conventional axis system, comprising an axial direction 30 (which is aligned with the rotational axis 11), a radial direction 40, and a circumferential direction 50 (shown perpendicular to the page in the FIG. 1 view). The axial, radial and circumferential directions 30, 40, 50 are mutually perpendicular.

The fan stage 13 comprises a plurality of fan blades 100 extending from a hub 200. The fan blades 100 may be defined with respect to the axial direction 30, radial direction 40, and circumferential direction 50 shown in FIG. 1 in relation to the gas turbine engine 10.

In general, the fan stage 13 (which may be referred to simply as the fan 13) has a hub to tip ratio, which may be defined as the radius of the leading edge of the fan blades 100 at the point where they extend away from the hub 200 (labelled r_{hub} in FIG. 1) divided by the radius of the leading edge of the fan blades 100 at their tip 150 (labelled rₜᵢₚ in FIG. 1). The hub to tip ratio (r_{hub}/rₜᵢₚ) may be in the ranges described and/or claimed elsewhere herein.

FIG. 2 is a side view (that is, a view in the axial-radial plane) of a fan blade 100 in accordance with the present disclosure. The fan blade 100 has an aerofoil portion 110. The aerofoil portion 110 has a leading edge 120 and a trailing edge 130. The aerofoil portion 110 extends from a root 140 to a tip 150 in a substantially radial spanwise direction. The leading edge 120 may be defined as the line defined by the axially forwardmost points of the aerofoil portion 110 from its root 140 to its tip 150.

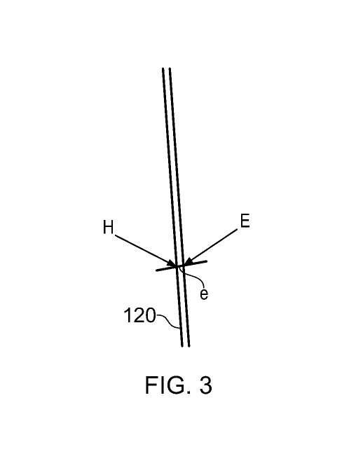

Various features of an exemplary fan blade 100 will now be described with reference to FIGS. 2 and 3. It will be appreciated that these features may be applied alone or in combination, as defined in the claims. The variables shown in FIGS. 2 and 3 are explained in the table below, where the term “LE” refers to the leading edge 120, and the term “TE” refers to the trailing edge 130:

| Point | Name | Definition |
|---|---|---|
| A | LE root | Leading edge 120 at the root 140 of the |
| | | aerofoil 110 |
| B | TE root | Trailing edge 130 at the root 140 of the |
| | | aerofoil 110 |
| C | LE tip | Leading edge 120 at the tip 150 of the aerofoil |
| | | 110 |
| D | TE tip | Trailing edge 130 at the tip 150 of the aerofoil |
| | | 110 |
| P1, P2 | LE points | Points on leading edge 120 with radii that are at |
| | | least a percentage (for example 2% or 5%) of |
| | | the aerofoil span apart, and between the radii of |
| | | point F on the leading edge at 60% of the |
| | | aerofoil span from the LE root A and LE Tip C |
| | | e.g. |
| | | $\begin{matrix}\frac{\vert {r}_{P 1} - {r}_{P 2} \vert}{{r}_{C} - {r}_{A}} \geq e . g . 0.05 or 0.02 ; {r}_{P 2} \geq {r}_{P 1} ; \\ {r}_{A} + 0.6 ( {r}_{C} - {r}_{A} ) \leq {r}_{P 1} , {r}_{P 2} \leq {r}_{C}\end{matrix}$ |
| P3, P4 | LE points | Points on leading edge 120 with radii that are at |
| | | least a percentage (for example 2% or 5%) of |
| | | the aerofoil span apart, and between the radii of |
| | | the LE root A and the point F on the leading |
| | | edge at 60% of the aerofoil span from the root |
| | | A, e.g. |
| | | $\begin{matrix}\frac{\vert {r}_{P 4} - {r}_{P 3} \vert}{{r}_{C} - {r}_{A}} \geq 0.05 ; {r}_{P 3} \geq {r}_{P 4} ; \\ {r}_{A} \leq {r}_{P 3} , {r}_{P 4} \leq {r}_{A} + 0.6 ( {r}_{C} - {r}_{A} )\end{matrix}$ |
| E | Point on LE | Point on leading edge 120 with maximum |
| | | perpendicular distance to the line AC |
| H | Point on AC | |
| e | Distance EH | $e = \sqrt{{( {x}_{H} - {x}_{E} )}^{2} + {( {r}_{H} - {r}_{E} )}^{2}}$ |
| Alpha α | LE global slope | $∝ = \frac{180}{π} atan ( \frac{{x}_{c} - {x}_{A}}{{r}_{c} - {r}_{A}} )$ |
| alpha (P1,P2) | LE local slope − radially outer half | $∝ ( P 1 , P 2 ) = \frac{180}{π} atan ( \frac{{x}_{P 2} - {x}_{P 1}}{{r}_{P 2} - {r}_{P 1}} )$ |
| alpha (P3,P4) | LE local slope − radially inner half | $∝ ( P 3 , P 4 ) = \frac{180}{π} atan ( \frac{{x}_{P 3} - {x}_{P 4}}{{r}_{P 3} - {r}_{P 4}} )$ |
| e% | LE “straightness” | $e \% = \frac{e}{{r}_{C} - {r}_{A}} 100$ |
| Span | Aerofoil Span | Difference in the radius of the leading edge |
| | | 120 at the root 140 and at the tip 150: r_{C} − r_{A} |
| F | Aerofoil span | Radius of the leading edge 120 at radial |
| | 60% point | position 60% between root 140 and tip 150 |
| | | from root 140: r_{A} + 0.6 (r_{C} − r_{A}) |

Note in the above table, that “x” refers to a position in the axial direction 30 and “r” refers to a position in the radial direction 40.

For any two points P1, P2 on the leading edge that are in the region 300 that is the radially outer 40% of the blade span (i.e. radially outboard of the point F shown in FIG. 2), for example radially closer to the leading edge tip C than to the leading edge root A, and are separated by at least 1%, for example at least 2%, for example at least 3%, for example at least 4%, for example at least 5% of the span, the radially outer point P2 is axially forward of the radially inner point P1. Such points P1, P2 may be described as being radially outside (or as having a greater radius than) the point F on the aerofoil that is 60% of the span from the leading edge root A.

For points P3, P4 that are on the leading edge that are in the region 310 that is the radially inner 60% of the blade span (i.e. radially inside of the point F shown in FIG. 2), for example radially closer to the leading edge root A than to the leading edge tip C, and are separated by at least 1%, for example at least 2%, for example at least 3%, for example at least 4%, for example at least 5% of the span, the radially outer point P3 may either be axially forward (as in the FIG. 2 example) or axially rearward of the radially inner point P4. Such points P3, P4 may be described as being radially inside (or as having a smaller radius than) the point F on the aerofoil that is 60% of the span from the leading edge root A. The leading edge 120 of the aerofoil 100 may have any desired shape in the region 310.

Optionally, the global slope ∝ of the aerofoil portion 110 of fan blades 100 as described and/or claimed herein, such as that shown by way of example in FIG. 2, may be in the range of from −6° and −0.2°, for example within any of the ranges defined elsewhere herein. In this regard, the global slope ∝ may represent the angle formed between the radial direction and a straight line AC drawn between the leading edge point A at the root 140 and the leading edge point C at the tip 150.

Optionally, the local slope ∝ (P1, P2), ∝ (P3, P4) of the aerofoil portion 110 of fan blades 100 as described and/or claimed herein, such as that shown by way of example in FIG. 2, may be in the range of from −6° and 0°, for example within any of the ranges defined elsewhere herein. In this regard, the local slope ∝ (P1, P2), ∝ (P3, P4) may represent the angle formed between the radial direction and a line drawn between any two points on the leading edge that have a difference in radius of at least 1%, for example at least 2%, for example at least 3%, for example at least 4%, for example at least 5% of the blade span.

The relationship between ‘E’ and ‘H’ as defined in the table above is seen most easily in FIG. 3. The distance ‘e’ between the points ‘E’ and ‘H’ may be said to represent the maximum perpendicular distance between any point on the leading edge and a straight line drawn between the leading edge at the root. As a percentage (‘e %’) the distance ‘e’ of the aerofoil portion 110 of fan blades 100 as described and/or claimed herein may be less than 5%, for example less than 2% (or any other range as described and/or claimed herein) of the span of the aerofoil portion 110. However, it will be appreciated that some arrangements of the present disclosure may have a relationship between ‘E’ and ‘H’ that is outside this range.

The trailing edge 130 of the aerofoil portion 110 may also define a global slope β. The global slope β of the trailing edge 130 of fan blades 100 may be in the range of from −40° and 0°, for example −30° and −1°, for example −25° and −2.5°, for example −20° and −5°, for example −15° and −7.5°, for example around −10°. In this regard, the global slope β of the trailing edge 130 may represent the angle between the radial direction and a straight line I drawn between a point B on the trailing edge 130 at the root 140 and a point D on the trailing edge 130 at the tip 150.

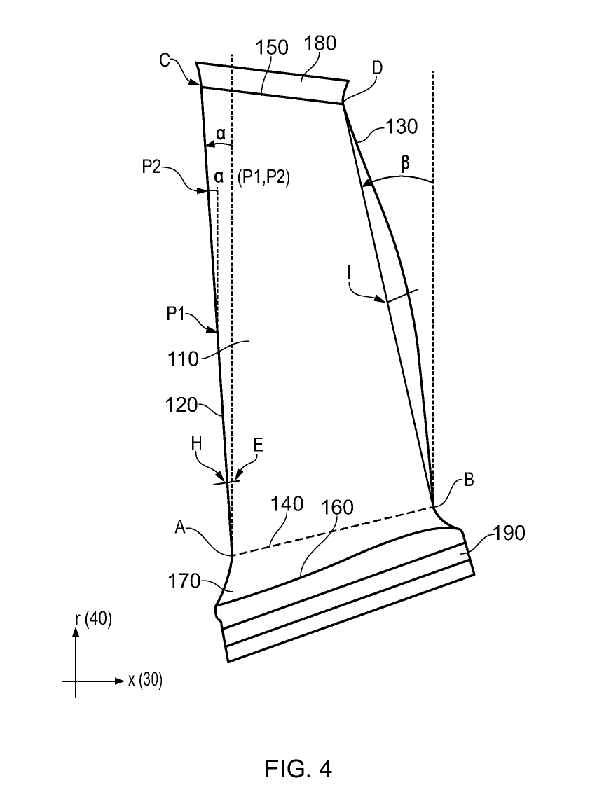

The fan blade 100 comprises a platform 160. The aerofoil portion 110 may extend directly from the platform 160, as in the FIG. 2 example. Alternatively, as shown by way of example in FIG. 4, a fan blade 100 may have a root portion 170. The root portion 170 may be said to extend between the platform 160 and the root 140 of the aerofoil portion 110. The radial extent of the root portion 170 may be no more than 7%, for example no more than 5%, of the span of the aerofoil portion 110.

Also as shown by way of example in FIG. 4, the fan blade 100 may comprise a tip portion 180. The tip portion 180 may be said to extend from the tip 150 of the aerofoil portion 110. The radial extent of the tip portion 180 may be no more than 5% of the span of the aerofoil portion 110.

The fan blade 100 may be attached to the hub 200 in any desired manner. For example, the fan blade 100 may comprise a fixture 190 such as that shown by way of example in FIG. 6 which may engage a corresponding slot in the hub (or disc). Purely by way of example, such a fixture may be in the form of a dovetail that may slot into and/or engage a corresponding slot in the hub/disc in order to fix the fan blade to the hub/disc.

Alternatively, the fan blade 100 and the hub 200 may be formed as a unitary part, with no mechanical and/or releasable connections, so as to form a unitary fan stage 13. Such a unitary fan stage 13 may be referred to as a “blisk”. Such a unitary fan stage 13 may be manufactured in any suitable manner, for example by machining and/or by linear friction welding the fan blades 100 to the hub 200, or at least linear friction welding the aerofoil portions 110 to a hub 200 that includes radially inner stub portions of the fan blades 100.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A fan stage for a gas turbine engine, the fan stage defining axial, radial and circumferential directions, the fan stage comprising a plurality of fan blades extending from a hub, wherein:
each fan blade comprises an aerofoil portion having a leading edge extending from a root to a tip the radial distance between the leading edge at the root (A) and the leading edge at the tip (C) defining a blade span;
for any two points (P1, P2) on the leading edge of a fan blade that are in the radially outer 40% of the blade span and are radially separated by at least 5% of the blade span, the radially outer of the two points is axially forward of the radially inner point; and
the radius of the leading edge of a given fan blade at the hub divided by the radius of the leading edge of the fan blade at the tip is less than or equal to 0.3.

2. A fan stage for a gas turbine engine according to claim 1, wherein:
for any two points (P1, P2) on the leading edge of the fan blade that are radially closer to the tip than to the root and are radially separated by at least 5% of the blade span, the radially outer of the two points is axially forward of the radially inner point.

3. A fan stage according to claim 1, wherein for any two points (P1, P2) on the leading edge of the fan blade that are in the radially outer 40% of the blade span and have a difference in radius of at least 2% of the blade span, the radially outer of the two points is axially forward of the radially inner point.

4. A fan stage according to claim 1, wherein for any two points (P1, P2) on the leading edge of the fan blade that are radially closer to the tip than to the root and have a difference in radius of at least 2% of the blade span, the radially outer of the two points is axially forward of the radially inner point.

5. A fan stage according to claim 1, wherein for any two points (P1, P2) on the leading edge of a fan blade that are radially separated by at least 5% of the blade span, the radially outer of the two points is axially forward of the radially inner point.

6. A fan stage according to claim 1, wherein, when viewed along a circumferential direction, the angle (α (P1, P2)) formed between the radial direction and a line drawn between the two points (P1, P2) on the leading edge is in the range of from −6° and 0°,
where a negative angle indicates that the respective line has an axial component that is in the same direction as the axial component of the direction from a trailing edge to the leading edge of the blade.

7. A fan stage according to claim 1, wherein, when viewed along a circumferential direction, the angle (α) formed between the radial direction and a straight line (AC) drawn between the leading edge at the root and at the tip of any given fan blade is in the range of from −6° and −0.2°,
where a negative angle indicates that the respective line has an axial component that is in the same direction as the axial component of the direction from a trailing edge to the leading edge of the blade.

8. A fan stage according to claim 1, wherein:
the maximum perpendicular distance (e) between any point on the leading edge of any given fan blade and a straight line drawn between the leading edge at the root and at the tip is 2% of the blade span.

9. A fan stage according to claim 1, wherein each fan blade comprises:
a platform; and
a root portion, wherein
the root portion extends between the platform and the root of the aerofoil portion.

10. A fan stage according to claim 9, wherein the radial extent of the root portion of each fan blade is no more than 7% of the span of the aerofoil portion.

11. A fan stage according to claim 1, wherein each fan blade comprises a tip portion that extends at least radially away from the tip of the aerofoil portion.

12. A fan stage according to claim 11, wherein the radial extent of the tip portion of each fan blade is no more than 7% of the span of the aerofoil portion.

13. A fan stage according to claim 1, wherein the aerofoil portion of each fan blade has a trailing edge extending from the root to the tip, wherein, when viewed along a circumferential direction the angle (β) formed between the radial direction and a straight line (BD) drawn between the trailing edge at the root and at the tip is in the range of from −20° and −5°, where a negative angle indicates that the respective line has an axial component that is in the same direction as the axial component of the direction from a trailing edge to the leading edge of the blade.

14. A gas turbine engine comprising a fan stage according to claim 1.

15. A gas turbine engine according to claim 14, further comprising:
a turbine; and
a gearbox, wherein:
the fan stage is driven from the turbine via the gearbox, in order to reduce the rotational speed of the fan stage compared with the driving turbine stage.

16. A gas turbine engine according to claim 14 with a specific thrust of less than 100 N/Kg/s.

17. A gas turbine engine according to claim 15 with a specific thrust of less than 100 N/Kg/s.

18. A method of manufacturing a fan stage, the fan stage defining axial, radial and circumferential directions, the fan stage comprising a plurality of fan blades extending from a hub, wherein each fan blade comprises an aerofoil portion having a leading edge extending from a root to a tip the radial distance between the leading edge at the root (A) and the leading edge at the tip (C) defining a blade span;
for any two points (P1, P2) on the leading edge of a fan blade that are in the radially outer 40% of the blade span and are radially separated by at least 5% of the blade span, the radially outer of the two points is axially forward of the radially inner point;
and the radius of the leading edge of a given fan blade at the hub divided by the radius of the leading edge of the fan blade at the tip is less than or equal to 0.3, the method comprising:
providing the fan hub; and
attaching the plurality of fan blades to the fan hub using linear friction welding.
